(19) United States
(12) Patent Application Publication
(10) Pub. No.: US 2014/0058721 A1
(43) Pub. Date: Feb. 27, 2014

(54) REAL TIME STATISTICS FOR CONTACT CENTER MOOD ANALYSIS METHOD AND APPARATUS

(71) Applicant: Diego Becerra, Montevideo (UY)

(72) Inventor: Diego Becerra, Montevideo (UY)

(73) Assignee: AVAYA INC., Basking Ridge, NJ (US)

(21) Appl. No.: 13/594,283

(22) Filed: Aug. 24, 2012

(51) Int. Cl. G06F 17/27

(52) U.S. Cl. 704/9

(57) ABSTRACT

Methods and systems for providing a graphical depiction of a determined sentiment for a contact received at a contact center are provided. Moreover, the determined sentiment can be displayed for a grouping of contacts as an aggregated sentiment. The sentiment or aggregated sentiment can be displayed in real time or near real time.

### FIELD

Methods and systems for providing real time statistics for contact center mood analysis are described.

### BACKGROUND

Contact centers, which typically are associated with human agents, are used to provide customer service and support. In addition to voice calls, contact centers can handle different types of media. For example, contact centers can receive electronic communications comprising emails, text messages, instant messages, or other written communications. One of the main concerns of a multimedia contact center is how to measure or sense the satisfaction of those customers that communicate with the contact center. However, in connection with written communications, it can be difficult to determine the mood of the customer or other person initiating the contact. In particular, by reading a written message, it is rarely possible to recognize how satisfied the customer is about the service, or to determine which agents are not correctly satisfying customers.

Most written communications are composed of some facts and some degree of emotion or sentiment. The better understanding that the contact center has about the customer's sentiment, the easier it is to take proactive measures to improve customer satisfaction. Textual analytics tools have been developed to process and extract sentiment from customer opinions. However, the sentiment extracted has not been analyzed and made available to contact center agents in a readily accessible way. Accordingly, contact centers have not been able to adequately gauge or react to customer sentiment.

### SUMMARY

Systems and methods that provide a sentiment indicator are provided. More particularly, contacts received at a contact center in the form of written electronic communications are analyzed to determine an associated sentiment. The determined sentiment is displayed as a sentiment indicator to agents and/or supervisors. The contact center agents can then adjust the service being provided to customers based on the sentiment indicator or indicators.

In accordance with at least some embodiments of the present disclosure, contacts received at a contact center are analyzed by an analysis engine. For example, individual written communications, received from customers in electronic form, are analyzed to determine an associated sentiment. Moreover, the analysis engine can aggregate data collected with respect to a plurality of individual electronic communications received at the contact center. The aggregated data can be viewed in various ways, including according to customer, agent, contact center service, contact center skill set, a group of contact center agents, a group of customers, a time period, or a keyword identified in the communication. The sentiment or aggregated sentiment can then be displayed to a contact center agent and/or supervisor. Moreover, the sentiment can be displayed in real time or near real time. The contact center agents and/or supervisors can then take action in response to the sentiment indicator.

Systems implementing embodiments of the present disclosure can provide a contact center server with application programming that is operable to analyze contacts in the form of written, electronic communications. More particularly, the communication server can include an analysis engine and an automatic call distribution application. The automatic call distribution application can assign contacts to agents conventionally. The analysis engine can analyze the contacts to determine an associated sentiment. Examples of a determined sentiment include, but are not limited to satisfied, dissatisfied, and agitated. In addition to determining an associated sentiment, the analysis engine can categorize contacts in various ways. For example, contacts can be categorized according to the customer source, agent, contact center service, contact center skill set, group of contact center agents, group of customers, a time period, or a keyword included in the electronic communication. The analysis engine can further aggregate the sentiment from a plurality of electronic communications or contacts. Moreover, the aggregated data can be grouped according to one or more determined attributes. A sentiment indicator related to individual contacts and/or aggregated contacts, based on the determined sentiment for the individual contact and/or aggregation or grouping of contacts, can then be visually displayed, for example, through an agent workstation or supervisor workstation.

Additional features and advantages of embodiments of the present invention will become more readily apparent from the following description, particularly when taken together with the accompanying drawings.

### BRIEF DESCRIPTION OF THE DRAWINGS

FIG. 1 is a block diagram depicting components of a system in accordance with embodiments of the present disclosure;

FIG. 2 is a block diagram of a contact center server in accordance with embodiments of the present disclosure;

FIG. 3 depicts a user interface in accordance with embodiments of the present disclosure; and

FIG. 4 is a flowchart depicting aspects of a method in accordance with embodiments of the present disclosure.

### DETAILED DESCRIPTION

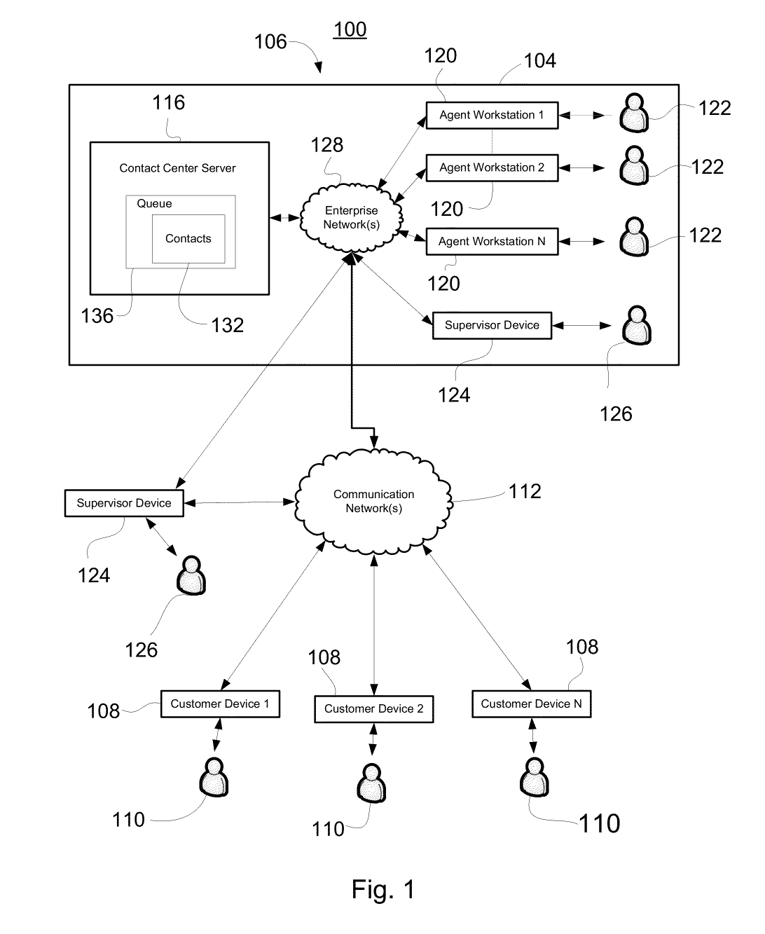

FIG. 1 is a block diagram depicting components of a communication system 100 in accordance with embodiments of the present invention. In particular, the communication system 100 includes a contact center 104. In general, the contact center 104 can be in communication with one or more customer endpoints or devices 108 via one or more communication networks 112. Examples of customer endpoints 108 include but are not limited to smartphones, desktop computers, laptop computers, or any other device capable of supporting communications between a customer and a customer service or other agent associated with the contact center 104 using written, electronic communications. Accordingly, communications between the contact center 104 and the customer endpoints 108 can comprise email, instant messaging, short message system, or other real time or non-real time text based, electronic communications. The communication network 112 can include the Internet, a local area network (LAN), wide area network (WAN), public switched telephone network (PSTN), wireless networks, or a plurality of networks in any combination.

The contact center 104 generally includes a call or contact center server 116, such as an automatic contact (or call) distribution system (ACD) server 116. The ACD server 116 is illustratively the Communication Manager™ enterprise communication-based ACD system available from Avaya Inc. The ACD server is interconnected to a plurality of agent workstations or endpoints 120. For example, the agent workstations 120 may be connected to the ACD server 116 by an enterprise network or networks 128.

The contact center server 116 generally functions to connect agent workstations 120 to customer devices or endpoints 108 through the communication network 112, to allow the agents 122 to service customer 110 contacts 132. In accordance with embodiments of the present disclosure, the contacts comprise written, electronic communications. However, contacts are not necessarily limited to written communications. For example, the contact center 106 can additionally handle voice contacts. As can be appreciated by one of skill in the art after consideration of the present disclosure, the contact center server 116 can maintain one or more queues 136 for organizing and maintaining or holding contacts 132 waiting for handling by a contact center agent 122. For example, a plurality of queues 136 can be provided to sort contacts according to various parameters. Agents 122 associated with the agent workstations 120 are assigned to provide services to contacts 132 that have been placed within one or more of the queues 136 based on availability and/or weighting factors. Moreover, the workstations 120, which can comprise general purpose computers, thin client devices, or other devices, generally support the delivery of customer contacts to associated agents 122, and to receive replies to the customer contacts from the agents 122. In addition, the agent workstations 120 can include a user output in the form of a display that can present a determined sentiment or sentiment indicator for a contact, or aggregation of contacts, to associated agents 122.

In addition, embodiments of a system 100 as described herein can include one or more supervisor or administrator devices 124. The supervisor device 124 is generally in communication with the contact center server 116 via the communication network 112 and/or the enterprise network 128. For example, if the supervisor device 124 is on the premises of the contact center 104, communications with the contact center server 116 may be over a portion of the enterprise network 128 comprising a wireline or wireless network. As another example, the supervisor device 124 may be in communication with the contact center server 116 over the communication network 112, for example via a cellular telephony data network, a wired or wireless connection outside of the enterprise network 128, or the like. In general, the supervisor device 124 comprises functionality that allows a supervisor 126 to monitor the health of the contact center 104, and to control aspects of the operation of the contact center 104. Moreover, the supervisor device 124 can present a sentiment indicator for a contact or aggregation of contacts to a supervisor 126. Accordingly, the supervisor device 124 can comprise any device, including a mobile device, capable of presenting information to a supervisor 126. Accordingly, examples of a supervisor device 124 include, but are not limited to, a tablet computer, a smartphone, a laptop computer, a desktop computer, a netbook, or the like.

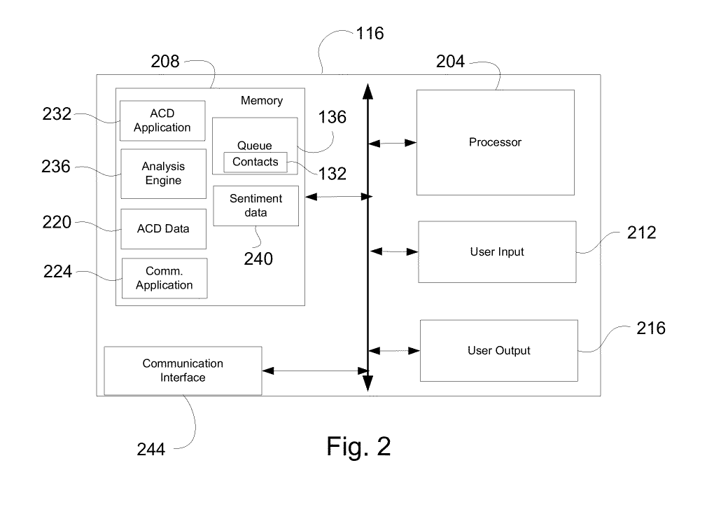

FIG. 2 is a block diagram depicting components of a contact center server 116 in accordance with embodiments of the present disclosure. The contact center server 116 includes a processor 204 capable of executing program instructions. The processor 204 can include any general purpose programmable processor or controller for executing application programming. Alternatively, the processor 204 may comprise a specially configured application specific integrated circuit (ASIC). The processor 204 generally functions to run programming code implementing various functions performed by the contact center server 116. For example, the processor 204 can implement functions including automatic call distribution functions performed in connection with the execution of an ACD application 232, and the determination and analysis, including aggregation, of sentiment associated with contacts by an analysis engine 236 as described herein.

The contact center server 116 additionally includes memory 208. The memory 208 can be used in connection with the execution of programming by the processor 204 of the contact center server 116, and for the temporary or long term storage of data and/or program instructions. For example, the contact center server 116 can include the automatic call distribution (ACD) application 232 and the analysis engine 236. In addition, the memory 208 can function to store automatic call distribution data 220, one or more communication applications 224, data comprising one or more queues 136 of contacts 132, and contact sentiment data 240 determined by the analysis engine 236 as described herein. The memory 208 of the contact center server 116 can include solid state memory that is resident, removable and/or remote in nature, such as DRAM and SDRAM. Moreover, the memory 208 can include a plurality of discrete components of different types and/or a plurality of logical partitions. In accordance with still other embodiments, the memory 208 comprises a non-transitory computer readable storage medium. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read.

In addition, user input devices 212 and user output devices 216 may be provided. With respect to the communication server 116, such devices 212 and 216 can be used in connection with the monitoring and control of the contact center 104 by a supervisor 126 and/or an agent 112. However, a supervisor 126 or agent 122 typically interfaces with the contact center 116 through a supervisor device 124 or agent workstation 120, where the supervisor device 124 or agent workstation 120 each are associated with one or more user inputs and one or more user outputs. Examples of user input devices 212 include a keyboard, a numeric keypad, a touch screen, a microphone, scanner, and pointing device combined with a screen or other position encoder. Examples of user output devices 216 include a display, a touch screen display, a speaker, and a printer. The contact center server 116 also generally includes a communication interface 244 to interconnect the communication server 116 to the networks 112 and/or 128.

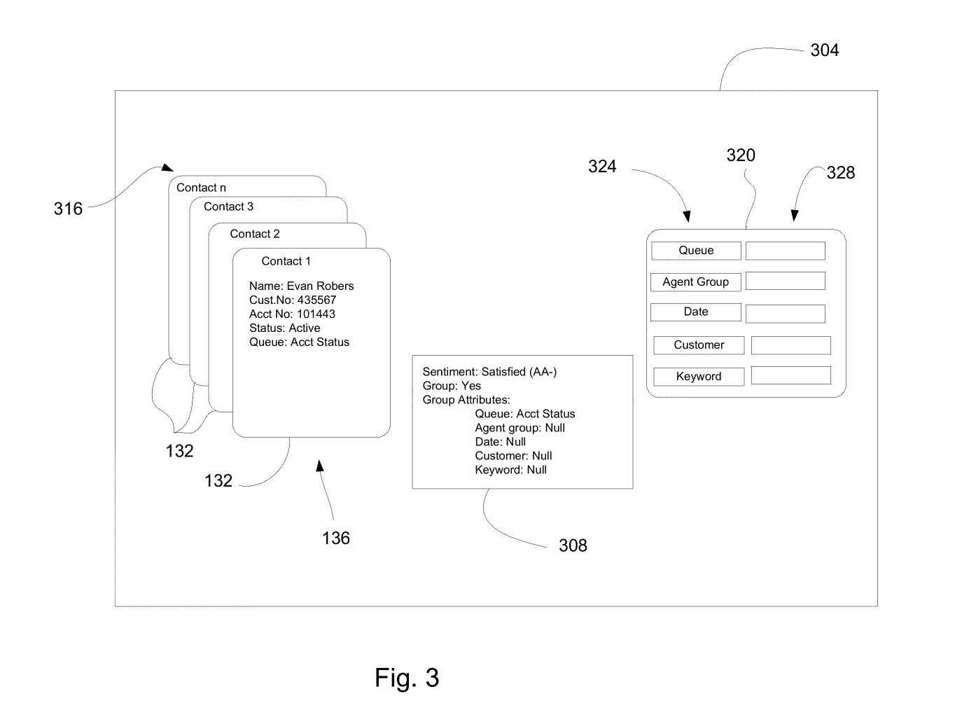

FIG. 3 depicts a user interface 304 in accordance with embodiments of the present disclosure. The user interface 304 can be provided by or in connection with a user output device (e.g., a display) of an agent workstation 120 or supervisor device 124. The user interface 304 can be generated through or in connection with the operation of the analysis engine 236 running on the contact center server 116, and/or in connection with a companion application, such as a specially provided application and/or a browser application, provided as part of an agent workstation 120 or supervisor device 124. Accordingly, the user interface 304 is generally presented to an agent 122 or supervisor 126. Moreover, the user interface 304 can be interactive in that it can provide fields, or agents, buttons, menus, or other features to enable the user interface 304 to receive input from an agent 122 or a supervisor 126, as well as to present information to the agent 122 or supervisor 126 graphically.

The user interface 304 can present information regarding the sentiment of a contact or contacts received at the contact center 104 in the form of a sentiment indicator 308. More particularly, at least one contact is analyzed by the analysis engine application 236 executed by the contact center server 116, and an associated sentiment determined for the contact or grouping of contacts is presented by the user interface 304. The sentiment indicator 308 can communicate the determined sentiment in various ways. For example, the sentiment indicator 308 can describe the determined sentiment through a word (e.g., satisfied, dissatisfied, agitated, etc.). Alternatively or in addition, the sentiment indicator 308 can provide a score depicting a level of urgency determined from the analysis, where the level of urgency indicates a degree of urgency from the perspective of an enterprise or other entity concerned with handling the contact. The sentiment indicator 308 can also assign color codes, numeric codes, icons, or other codes or graphics to indicate to an agent 122 and/or supervisor 126 a determined sentiment.

In accordance with still other embodiments of the present disclosure, the sentiment indicator 308 can provide a determined sentiment for one or more contacts 132. Accordingly, in addition to providing a sentiment for a single contact 132, the sentiment indicator 308 can provide an aggregated or overall sentiment for a grouping of contacts 132. Moreover, the contacts 132 included in a grouping 316 can be determined according to various parameters or characteristics. For example, the grouping 316 illustrated in FIG. 3 comprises a queue 136 of contacts 132. As other examples, the contacts 132 included in a grouping or aggregation 316 from which an aggregated sentiment is determined can be selected according to their associated customer, agent, contact center service, contact center skill set, group of contact center agents, group of customers, a time period, or a keyword included in the contact, alone or in combination, as parameters for determining groups or aggregations of contacts 132. The contacts 132 within a group 316 can further be displayed in a ranked order. For example, the contacts 132 may be ranked according to their associated sentiment.

The user interface 304 can include controls 320 that allow the agent 122 or supervisor 126 to view a determined sentiment for different contacts 312 and/or groupings of contacts 316. As examples, the controls 320 can allow a user to specify a queue 136, agent group, date or date range, customer, or keyword as parameters by which a grouping 316 is defined. For example, the controls 320 can provide a listing of parameters 324, each of which can be associated with a menu and/or input field 328 for receiving a user selection. The displayed sentiment 308 can include a determined sentiment for current contacts or groupings of contacts, or averages of contacts, generally or according to specified groupings, over some period of time. Where a sentiment indicator 308 includes historical sentiment data 240, such data can be retrieved from the contact center server 116. Moreover, multiple parameters may be selected simultaneously. For example, a user might define a grouping 316 by using the controls to specify that contacts 312 assigned to three different queues 228 over the past month with the keyword “recall” be included in that grouping. The selection by an agent 122 or a supervisor 126 to view such sentiment can cause the analysis engine 236 to generate the sentiment information being requested, or the aggregation being requested, for display by the user interface as a sentiment indicator 308. In addition, the sentiment indicator can include a display of the parameters applied to define a selection or grouping of contacts 312 that comprise the contact or contacts used to determine the sentiment depicted by the sentiment indicator 308.

In accordance with embodiments of the present disclosure, the user interface 304 therefore allows a user, such as an agent 122 or supervisor 126 to identify the mood within a certain grouping of contacts, a queue 228, or skill set, either currently or over a certain time period. Moreover, a current average sentiment could be viewed for all contacts associated with a contact center 104 or groupings of contacts within the contact center 104 over a limited time period. In accordance with embodiments of the present disclosure, a user interface 304 may comprise a dashboard display that can be accessed by an agent 122 or supervisor 126 while performing duties associated with responding to or otherwise handling contacts, and/or directing the operation of the contact center 104.

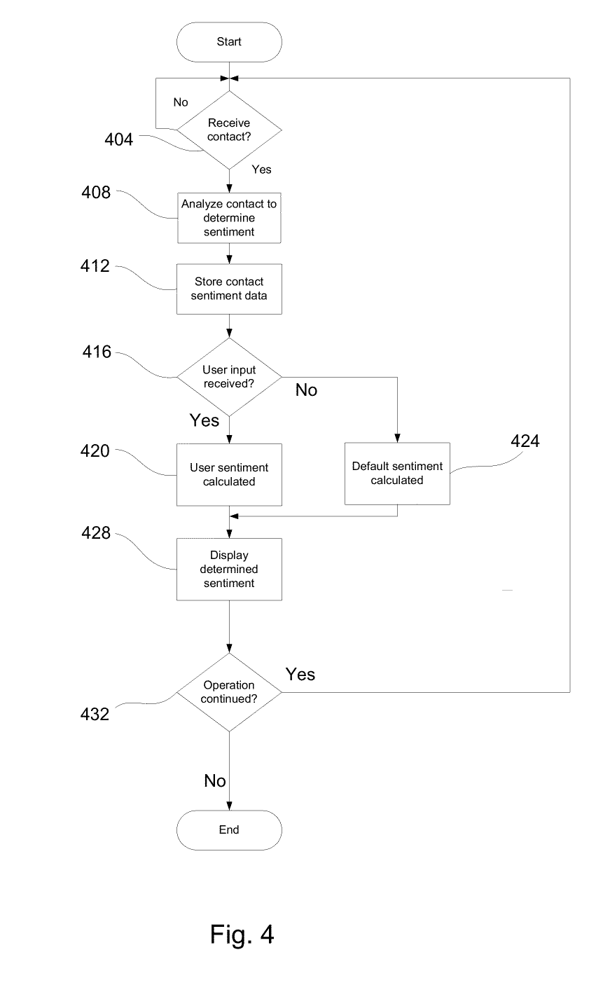

With reference now to FIG. 4, aspects of a method for providing real time statistics for contact mood analysis in accordance with embodiments of the present disclosure are depicted. Generally, the method begins with a determination as to whether a contact 132 has been received at the contact center 104 (step 404). Typically, the process idles at step 404 until a contact 132 has been received. At step 408, the contact 132 is analyzed to determine an associated sentiment. In accordance with embodiments of the present disclosure, a contact 132 includes an electronic communication. Moreover, the electronic communication may be in the form of a textual or written communication. The analysis is generally performed by the analysis engine application 236 executed by the contact center server 116. Alternatively or in addition, the analysis engine 236 can be executed by a dedicated analysis device associated with the contact center 104, either directly or through the cloud. The analysis of the contact to determine the sentiment can utilize various existing methodologies. In general, such methodologies can include opinion mining or sentiment analysis that can assign a sentiment value or polarity, like positive, negative, or neutral, to a given piece of text included in a contact. The determined sentiment for the contact can then be stored, for example as contact sentiment data 240 (step 412).

At step 416, a determination can be made as to whether the content of a sentiment indicator 308 to display to the user 122 or 126 has been specified. More particularly, a determination is made as to whether user input specifying the characteristics of contacts 132 whose sentiment is to be aggregated has been received. If such user input has been received, the user defined aggregated sentiment indicator 308 is calculated (step 420). Alternatively, if user input specifying a sentiment to be calculated and displayed is not received, the system 100 can calculate a default sentiment indicator 308 (step 424). As an example, a default sentiment indicator 308 may comprise the sentiment calculated with respect to the most recent contact 132 received at the communication server 116, or an average sentiment for all contacts 132 received within some preselected time period (step 424). A default sentiment indicator 308 may be different for different users 122 or 126. For example, a user comprising an agent 122 may receive a sentiment indicator 308 for all contacts 132 received in a queue or queues 136 for which the agent 122 is responsible, during the agent's shift, or some other time period. As another example, a default sentiment indicator 308 for a supervisor 126 may comprise an aggregated sentiment for all contacts 132 received in all queues 136 for which the supervisor 126 is responsible, during some predefined period of time.

The defined sentiment is then reported or displayed by the user interface 304 of the user's device 120 or 124 as a sentiment indicator 308 (step 428). In accordance with still other embodiments, the sentiment for a contact 312 or grouping 316 can be displayed to one or more agents 122 through associated workstations 120 simultaneously. Accordingly, an agent 122 can select context deemed to be the most urgent for handling before other contacts. A supervisor 126 can also define a grouping or aggregation for which a determined sentiment to be displayed as an aggregated sentiment indicator to one or more agents 122. In accordance with still other embodiments, the automatic call distribution application 232 can utilize the sentiment information for a contact 312 or grouping of contacts 316, as determined by the analysis engine 236, to control operation of the queue 228 and the assignment of contacts to individual agents 122.

At step 432, a determination is made as to whether operation of the analysis engine 236 is to continue. If operation is to continue, the process can return to step 404, and contacts 312 continue to be analyzed as they arrive at the contact center 104. Moreover, as new contacts are received, the sentiment indicator 308 can be updated. Accordingly, an instantaneous or near instantaneous sentiment indicator 308, displaying a current sentiment for groupings of contacts 132, or a most recent contact 132, can be presented. If operation is not continued, the process may end.

In accordance with at least some embodiments, the system 100 can operate to display as a sentiment indicator 308 a sentiment determined for a predefined contact 132 or grouping of contacts 132. For example, an agent 122 may be presented with a sentiment indicator 308 for a current contact 132. As another example, an agent 122 or supervisor 126 may be presented with a sentiment indicator 308 derived from a group 316 that includes the aggregated sentiment of all the contacts within a particular queue 136. A supervisor 126 and/or agent 122 can then change the displayed sentiment indicator 308, for example through entering selections in the controls 320. In accordance with still other embodiments, a user interface 304 can be operated to display multiple sentiment indicators 308 representing a sentiment for different contacts 132 or groupings of contacts 132 simultaneously. Moreover, the determined sentiment for different contacts 132 can be included in different aggregations of contacts 132. For example, a contact 132 containing a complaint about a product that is awaiting handling could be included in an aggregation of current contacts 132, an aggregation of contacts 132 regarding products, an aggregation of contacts 132 regarding complaints, an aggregation of contacts 132 associated with agents assigned to handle complaints, and contacts 132 associated with a queue 136 for handling complaints. Accordingly, multiple different aggregations of contacts 132 can be maintained simultaneously.

As can be appreciated by one of skill in the art after consideration of the present disclosure, the aggregation of determined sentiment for groupings of contacts can be particularly useful in connection with the administration of a contact center 104. For example, trends with respect to customer opinion, performance of various departments of an enterprise, performance of contact center agents, and the like, can be assessed. Moreover, embodiments of the present disclosure allow such assessments to be performed in real time or near real time. For example, where an instant or near real time average of determined sentiment is provided, the sentiment of the contacts in the recent past can be provided. Moreover, embodiments provide a visual representation of the sentiment, to provide a readily accessible indication of that sentiment to an agent 122 and/or supervisor 126.

As can be appreciated by one of skill in the art after consideration of the present disclosure, different users of the analysis engine 236 can be presented with different displays. For example, a supervisor 126 may have the ability to look at different aggregations of sentiment than agents 122. Moreover, a supervisor 126 may be provided with privileges that enable the supervisor to generate different aggregations of determined sentiment on request. In contrast, the privileges afforded an agent 122 with respect to control of the displayed sentiment can be more limited. For example, an individual agent 122 may be provided with the determined sentiment for only those contacts waiting for service in queues 228 for which the agent 122 concerned is assigned. In accordance with still other embodiments, the user interface 304 can enable users to control aspects of the operation of the contact center 104. For example, a supervisor 126 can be provided with the ability to control the assignment of different agents to different contacts or groupings of contacts, where such assignment or reassignment is informed by the sentiment indication provided to the supervisor 126.

As can be appreciated by one of skill in the art after consideration of the present disclosure, opinion mining or sentiment analysis may also be done on voicemail or voice recordings that can assign a sentiment value or polarity to a given recording. For example, the embodiments that provide a visual representation of a sentiment to provide a readily accessible indication of that sentiment to an agent 122 and/or supervisor 126 can apply to sentiment based on voice as well as electronic communications. Moreover, the same method might be employed where an automatic call distribution application 232 can utilize the sentiment information for a contact 312 or grouping of contacts 316, as determined by an analysis engine 236, to control operation of a queue 228 and an assignment of contacts to individual agents 122 based on the sentiment from the recordings.

The foregoing discussion of the invention has been presented for purposes of illustration and description. Further, the description is not intended to limit the invention to the form disclosed herein. Consequently, variations and modifications commensurate with the above teachings, within the skill or knowledge of the relevant art, are within the scope of the present invention. The embodiments described hereinabove are further intended to explain the best mode presently known of practicing the invention and to enable others skilled in the art to utilize the invention in such or in other embodiments and with various modifications required by the particular application or use of the invention. It is intended that the appended claims be construed to include alternative embodiments to the extent permitted by the prior art.

What is claimed is:

1. A method, comprising:
receiving a plurality of electronic communications at a contact center;
analyzing the plurality of electronic communications;
determining from the analysis of the plurality of electronic communications a sentiment associated with individual ones of the electronic communications included in the plurality of electronic communications; and
displaying a sentiment indicator, wherein the sentiment indicator is derived from the determined sentiment.

2. The method of claim 1, further comprising:
displaying a sentiment indicator for at least some of the individual ones of the electronic communications included in the plurality of electronic communications.

3. The method of claim 2, wherein the at least some of the individual ones of the electronic communications included in the plurality of electronic communications are displayed in a rank order, wherein the rank is derived from the determined sentiment.

4. The method of claim 1, further comprising:
aggregating the sentiment determined from at least some of the individual ones of the electronic communications included in the plurality of electronic communications, wherein the displayed sentiment is derived from the aggregated sentiment.

5. The method of claim 4, wherein the aggregated sentiment includes the determined sentiment from electronic communications related to a common parameter, wherein the common parameter is at least one of a contact center service, a contact center skill set, a contact center agent, a group of contact center agents, a customer, a group of customers, a timer period, or a keyword included in the electronic communication.

6. The method of claim 5, wherein the common parameter includes at least three of a contact center service, a contact center skill set, a contact center agent, a group of contact center agents, a customer, a group of customers, a timer period, or a keyword included in the electronic communication.

7. The method of claim 1, wherein the sentiment indicator includes an average sentiment for all electronic communications received at the contact center within a specified interval.

8. The method of claim 1, wherein the sentiment indicator is displayed as at least one of a color, a numeric value, a letter grade, a font size, a font type, or an animation.

9. The method of claim 1, wherein a current aggregated sentiment is recalculated for each electronic communication received at the contact center, and wherein a current aggregated sentiment is displayed to a user.

10. The method of claim 1, wherein the electronic communication is an electronic copy of a written communication.

11. A system, comprising:
a contact center server, including:
a communication interface;
a processor;
memory, wherein an analysis engine application is stored in the memory and executed by the processor, wherein the analysis engine operates to determine a sentiment for a contact received at the contact center server and to provide an output of an indication of the determined sentiment.

12. The system of claim 11, wherein the analysis engine further operates to aggregate the determined sentiment for a grouping of contacts received at the contact center server and to provide an output of the indication of the aggregated determined sentiment.

13. The system of claim 12, wherein the plurality of contacts comprise written communications.

14. The system of claim 12, wherein the analysis engine further operates to aggregate the determined sentiment for a plurality of groupings of contacts.

15. The system of claim 14, further comprising:
a first communication network, wherein the contacts are received at the contact center from the first communication network;
a second communication network, wherein the output of the indication of the aggregated determined sentiment is provided to one or more users over the second communication network.

16. The system of claim 15, further comprising:
at least one of an agent workstation and a supervisor device interconnected to the second communication network, wherein the output of the indication of the determined sentiment is displayed to the one or more users by the at least one of the agent workstation and the supervisor device.

17. A computer readable medium having stored thereon computer executable instructions, the computer readable instructions causing a processor to execute a method for facilitating mobile monitoring and control of a communication system that includes at least a first contact center, the computer readable instructions comprising:
instructions to determine a sentiment associated with a received contact;
instructions to receive user input defining a grouping of contacts to include in a sentiment indication;
instructions to determine a sentiment associated with the selected grouping of contacts;
instructions to display the determined sentiment through a user interface.

18. The computer readable medium of claim 17, wherein the instructions to determine a sentiment associated with the selected grouping of contacts include instructions to aggregate a determined sentiment for a plurality of contacts.

19. The computer readable medium of claim 18, wherein the contacts include written electronic communications.

20. The computer readable medium of claim 19, wherein the sentiment indicator is updated as new contacts are received.
